(19) United States
(12) Patent Application Publication
(10) Pub. No.: US 2014/0059595 A1
(43) Pub. Date: Feb. 27, 2014

(54) CONTEXT-AWARE VIDEO SYSTEMS AND METHODS

(71) Applicant: RealNetworks, Inc., Seattle, WA (US)

(72) Inventors: Joel JACOBSON, Seattle, WA (US); Philip SMITH, Seattle, WA (US); Phil AUSTIN, Maple Valley, WA (US); Senthil VAIYAPURI, Federal Way, WA (US); Satish KILARU, Seattle, WA (US); Ravishankar DHAMODARAN, Seattle, WA (US)

(73) Assignee: REALNETWORKS, INC., Seattle, WA (US)

(21) Appl. No.: 13/770,949

(22) Filed: Feb. 19, 2013

Related U.S. Application Data
(60) Provisional application No. 61/599,890, filed on Feb. 16, 2012.
(60) Provisional application No. 61/648,538, filed on May 17, 2012.
(60) Provisional application No. 61/658,766, filed on Jun. 12, 2012.

(51) Int. Cl. H04N 21/462; H04N 21/4722

(52) U.S. Cl. CPC H04N 21/4622; H04N 21/4722
USPC 725/34

(57) ABSTRACT

Media-playback devices may render context-aware media along with a continually updated set of selectable asset identifiers that correspond to assets (e.g., actors, locations, articles of clothing, business establishments, or the like) currently presented in the media. Using the currently-presented assets or asset controls, a viewer can access contextually relevant information about a selected asset.

### CROSS-REFERENCE TO RELATED APPLICATIONS

This application claims the benefit of priority to the following applications:
Provisional Patent Application No. 61/599,890, filed Feb. 16, 2012 under Attorney Docket No. REAL-2012377, titled “CONTEXTUAL ADVERTISING PLATFORM SYSTEMS AND METHODS”, and naming inventors Joel Jacobson et al.;
Provisional Patent Application No. 61/648,538, filed May 17, 2012 under Attorney

Docket No. REAL-2012389, titled “CONTEXTUAL ADVERTISING PLATFORM WORKFLOW SYSTEMS AND METHODS”, and naming inventors Joel Jacobson et al.; and
Provisional Patent Application No. 61/658,766, filed Jun. 12, 2012 under Attorney Docket No. REAL-2012395, titled “CONTEXTUAL ADVERTISING PLATFORM DISPLAY SYSTEMS AND METHODS”, and naming inventors Joel Jacobson et al.

The above-cited applications are hereby incorporated by reference, in their entireties, for all purposes.

### FIELD

The present disclosure relates to the field of computing, and more particularly, to a media player that provides continually updated context cues while it renders media data.

### BACKGROUND

In 1995, RealNetworks of Seattle, Wash. (then known as Progressive Networks) broadcast the first live event over the Internet, a baseball game between the Seattle Mariners and the New York Yankees. In the decades since, streaming media has become increasingly ubiquitous, and various business models have evolved around streaming media and advertising. Indeed, some analysts project that spending on on-line advertising will increase from $41B in 2012 to almost $68B in 2015, in part because many consumers enjoy consuming streaming media via laptops, tablets, set-top boxes, or other computing devices that potentially enable users to interact and engage with media in new ways.

For example, in some cases, consuming streaming media may give rise to numerous questions about the context presented by the streaming media. In response to viewing a given scene, a viewer may wonder “who is that actor?”, “what is that song?”, “where can I buy that jacket?”, or other like questions. However, existing streaming media services may not provide facilities for advertisers and content distributors to manage contextual metadata and offer contextually relevant information to viewers as they consume streaming media.

### BRIEF DESCRIPTION OF THE DRAWINGS

FIG. 1 illustrates a data object synchronization system in accordance with one embodiment.

FIG. 2 illustrates several components of an exemplary media-playback device in accordance with one embodiment.

FIG. 3 illustrates a routine for rendering context-aware media, such as may be performed by a media-playback device in accordance with one embodiment.

FIG. 4 illustrates a routine for presenting context data associated with a selected asset, such as may be performed by a media-playback device in accordance with one embodiment.

FIGS. 5-8 illustrate an exemplary context-aware media-rendering user interface, such as may be generated by media-playback device in accordance with one embodiment.

### DESCRIPTION

In various embodiments as described herein, media-playback devices may render context-aware media along with a continually updated set of selectable asset identifiers that correspond to assets (e.g., actors, locations, articles of clothing, business establishments, or the like) currently presented in the media. Using the currently-presented assets or asset controls, a viewer can access contextually relevant information about a selected asset.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

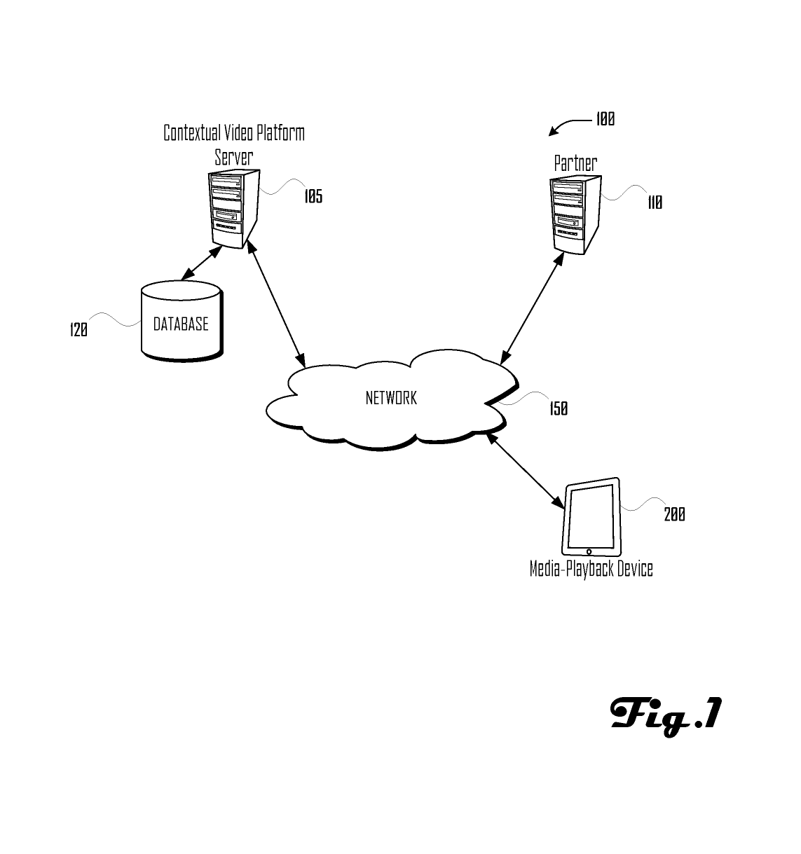

FIG. 1 illustrates a data object synchronization system in accordance with one embodiment. In the illustrated system, contextual video platform server 105, partner device 110, and media-playback device 200 are connected to network 150.

Contextual video platform server 105 is also in communication with database 120. In some embodiments, contextual video platform server 105 may communicate with database 120 via data network 150, a storage area network (“SAN”), a high-speed serial bus, and/or via the other suitable communication technology.

In various embodiments, contextual video platform server 105 and/or database 120 may comprise one or more physical and/or logical devices that collectively provide the functionalities described herein. In some embodiments, contextual video platform server 105 and/or database 120 may comprise one or more replicated and/or distributed physical or logical devices.

In some embodiments, contextual video platform server 105 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

In some embodiments, database 120 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

In various embodiments, partner device 110 may represent one or more devices operated by a content producer, owner, and/or distributor; an advertiser or sponsor; and/or other like entity that may have an interest in promoting viewer engagement with streamed media. In various embodiments, contextual video platform server 105 may provide facilities by which partner device 110 may add, edit, and/or otherwise manage asset definitions and context data.

In various embodiments, network 150 may include the Internet, a local area network (“LAN”), a wide area network (“WAN”), a cellular data network, and/or other data network. In various embodiments, media-playback device 200 may include a desktop PC, mobile phone, laptop, tablet, or other computing device that is capable of connecting to network 150 and rendering media data as described herein.

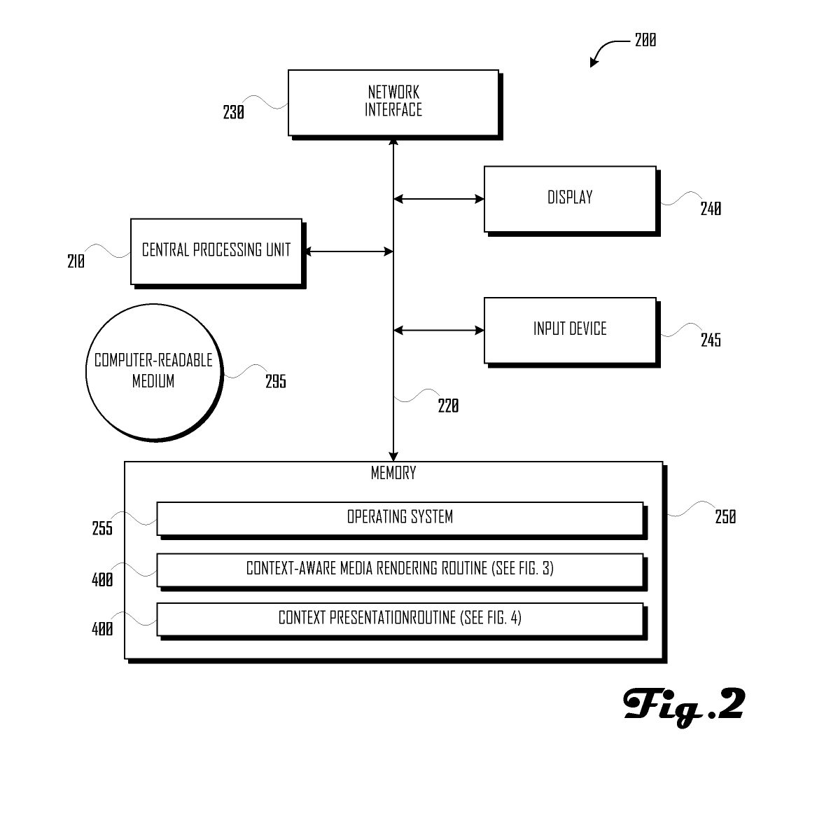

FIG. 2 illustrates several components of an exemplary media-playback device in accordance with one embodiment. In some embodiments, media-playback device 200 may include many more components than those shown in FIG. 2. However, it is not necessary that all of these generally conventional components be shown in order to disclose an illustrative embodiment.

Media-playback device 200 includes a bus 220 interconnecting components including a processing unit 210; a memory 250; display 240; input device 245; and network interface 230.

In various embodiments, input device 245 may include a mouse, track pad, touch screen, haptic input device, or other pointing and/or selection device.

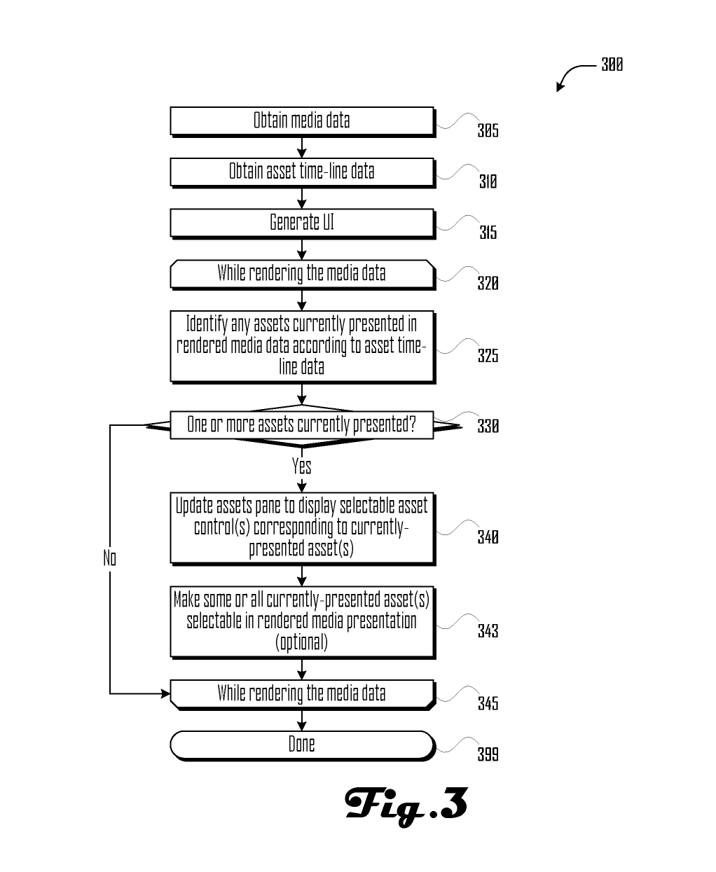

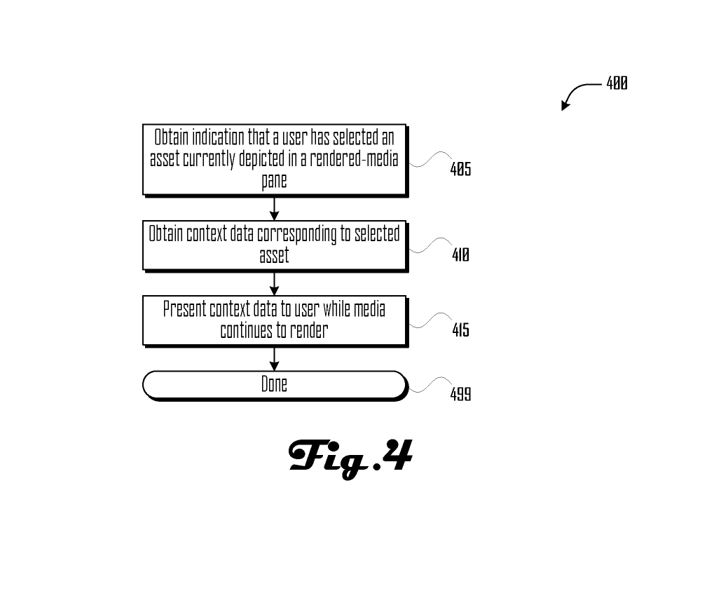

Memory 250 generally comprises a random access memory (“RAM”), a read only memory (“ROM”), and a permanent mass storage device, such as a disk drive. The memory 250 stores program code for a routine 300 for rendering context-aware media (see FIG. 3, discussed below) and a routine 400 for presenting context data associated with a selected asset (see FIG. 4, discussed below). In addition, the memory 250 also stores an operating system 255.

These and other software components may be loaded into memory 250 of media-playback device 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

FIG. 3 illustrates a routine 300 for rendering context-aware media, such as may be performed by a media-playback device 200 in accordance with one embodiment. [Para 27] In block 305, routine 300 obtains, e.g., from contextual video platform server 105, renderable media data. Typically, renderable media data includes computer-processable data derived from a digitized representation of a piece of media content, such as a video or other multimedia presentation. The renderable media data obtained in block 305 may include less than all of the data required to render the entire duration of the media presentation. For example, in one embodiment, the renderable media data may include a segment (e.g. 30 seconds) within a longer piece of content (e.g., a 22 minute video presentation).

In block 310, routine 300 obtains, e.g., from contextual video platform server 105, asset time-line data corresponding to a number of assets that are presented at various times during the duration of the renderable media data obtained in block 305.

For example, when the renderable media data obtained in block 305 is rendered for its duration (which may be shorter than the entire duration of the media presentation), various “assets” are presented at various points in time. For example, within a given 30-second scene, the actor “Art Arterton” may appear during the time range from 0-15 seconds, the actor “Betty Bing” may appear during the time range 12-30 seconds, the song “Pork Chop” may play in the soundtrack during the time range from 3-20 seconds, and a particular laptop computer may appear during the time range 20-30 seconds. In various embodiments, some or all of these actors, songs, and objects may be considered “assets” presented while the renderable media data is rendered.

As the term is used herein, an “asset” refers to objects, items, actors, and other entities that are specified by asset time-line data. However, it is not required that the asset time-line data include entries for each thing that may be presented while the renderable media data is rendered. For example, the actor “Carl Chung” may appear for some amount of time during a scene, but if the asset time-line data does not specify “Carl Chung” as an asset, then he is merely a non-asset entity that is presented alongside one or more assets while the scene is rendered.

In one embodiment, the asset time-line data may be stored in database 120 and provided by contextual video platform server 105 to media-playback device 200 as requested. For example, before rendering the renderable media data obtained in block 305, routine 300 may send to contextual video platform server 105 a request to identify assets that will be presented while the renderable media data is rendered. In other embodiments, some or all of the renderable media data and/or asset time-line data may be provided to media-playback device 200, which may store and/or cache the data until rendering time.

In some embodiments, the asset time-line data may include a data structure including asset entries having asset metadata such as some or all of the following.

{

“Asset ID”: “d13b7e51ec93”,
“Media ID”: “5d0b431d63f1”,
“Asset Type”: “Person”,
“AssetControl”: “/asset/d13b7e51ec93/thumbnail.jpg”,
“Asset Context Data”: “http://en.wikipedia.org/wiki/Art_Arterton”,
“Time Start”: 15,
“Time End”: 22.5,
“Coordinates”: [

0.35,
0.5

]

}

For purposes of this disclosure, the asset time-line data may be generated via any suitable means, including via automatic object-identification systems, manual editorial processes, crowd-sourced object-identification processes, and/or any combination thereof.

In block 315, routine 300 generates a user interface for rendering the renderable media data. For example, in one embodiment, routine 300 may generate a user interface including one or more features similar to those shown in user interface 500, user interface 700, and/or user interface 800, as discussed below. In particular, in various embodiments, the user interface generated in block 315 may include a media-playback pane for presenting the renderable media data obtained in block 305; an assets pane for presenting asset controls associated with currently-presented assets (discussed further below); and one or more optional context panes for presenting contextual information about one or more selected assets (discussed further below).

Routine 300 iterates from opening loop block 320 to ending loop block 345 while rendering the renderable media data obtained in block 305.

In block 325, routine 300 identifies zero or more assets that are presented during a current portion of the media data as it is being rendered in the media-playback pane of the user interface generated in block 315.

In practice, a “current portion” of the media data being rendered may refer to a contiguous set of frames, samples, images, or other sequentially presented units of media data, that when rendered at a given rate, are presented over a relatively brief period of time, such as 1, 5, 10, 30, or 60 seconds. In other words, a complete media presentation (e.g. a 22 minute video) may consist of a sequence of “current portions”, each having a duration such as 1, 5, 10, 30, or 60 seconds.

In some embodiments, the current loop of routine 300 may iterate at least once for each “current portion” of media. Routine 300 may therefore be considered to iterate “continually” while rendering the renderable media data obtained in block 305. As used herein, the term “continually” means to happen frequently, with intervals between (e.g., with intervals of 1, 5, 10, 30, or 60 seconds between iterations).

Thus, in one embodiment, each iteration of block 325 may continually identify zero or more assets that will be presented during the current or immediately upcoming 1, 5, 10, 30, or 60 seconds of rendered media.

As noted elsewhere in this disclosure, people, places, and/or objects may be depicted in a rendered video (or other media) without necessarily being an “asset” as the term is used herein. Rather, “assets” are those people, places, objects, and/or other entity that are tagged in the asset time-line data as being associated with a given portion of rendered media.

Similarly, to be “presented” means that an asset is tagged in the asset time-line data as being associated with a given portion of rendered media. In various embodiments, an asset may be tagged as “presented” in a given portion of media because the asset is literally depicted in that portion of media (e.g., a person or object is shown on screen during a given scene, a song is played in the soundtrack accompanying a given scene, or the like), because the asset is discussed by individuals depicted in a scene (e.g., characters in the scene discuss a commercial product, the scene is set in a particular location or at a particular business establishment, or the like), or because the asset is otherwise associated with a portion of media in some other way (e.g., the asset may be a commercial product or service whose provider has sponsored the media).

In some embodiments, identifying any assets that are presented during a current portion of the media data may include sending to contextual video platform server 105 a message requesting asset time-line data for the current or immediately upcoming portion of rendered media.

In decision block 330, routine 300 determines whether at least one asset was identified in block 325 as being presented during a current portion of the media data as it is being rendered in the media-playback pane of the user interface generated in block 315.

If so, then routine 300 proceeds to block 340. Otherwise, routine 300 proceeds to ending loop block 345.

In block 340, routine 300 updates the assets pane generated in block 315 to include a selectable asset control corresponding to each asset identified in block 325. In some embodiments, updating the assets pane may include displacing one or more asset controls corresponding to assets that were recently presented, but are no longer currently presented. In various embodiments, various animations or transitions may be employed in connection with displacing a no-longer-current asset control.

In some embodiments, in block 343, routine 300 may also make some or all of the asset identified in block(s) 325 selectable in the rendered media presentation, such that a user may optionally select an asset by touching, tapping, clicking, gesturing at, pointing at, or otherwise indicating within the rendered media itself. For example, in one embodiment, the asset time-line data obtained in block 310 may include coordinates data specifying a point, region, circle, polygon, or other specified portion of the rendered media presentation at which each asset identified in block 325 is currently depicted within a rendered video. In such embodiments, a user click, tap, touch, or other indication at a particular location within a video pane may be mapped to a currently displayed asset.

In ending loop block 345, routine 300 iterates back to opening loop block 320 if it is still rendering the renderable media data obtained in block 305.

When the renderable media data obtained in block 305 is no longer rendering, routine 300 ends in ending block 399.

FIG. 4 illustrates a routine 400 for presenting context data associated with a selected asset, such as may be performed by a media-playback device 200 in accordance with one embodiment.

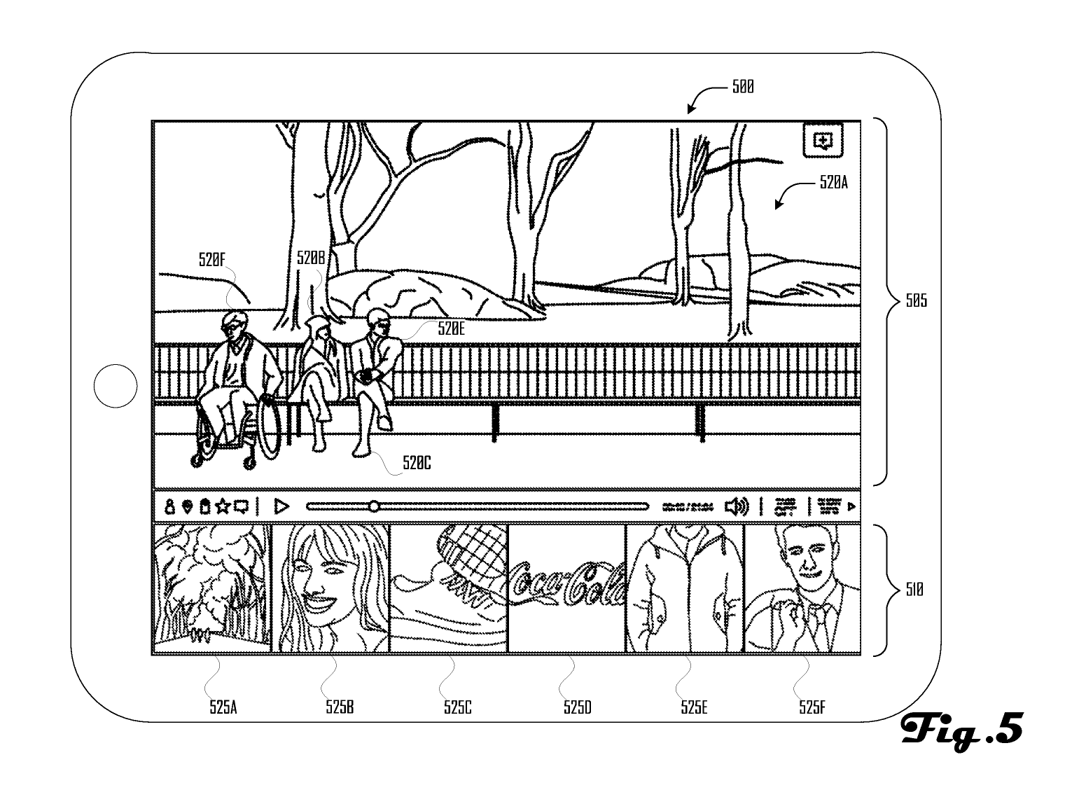

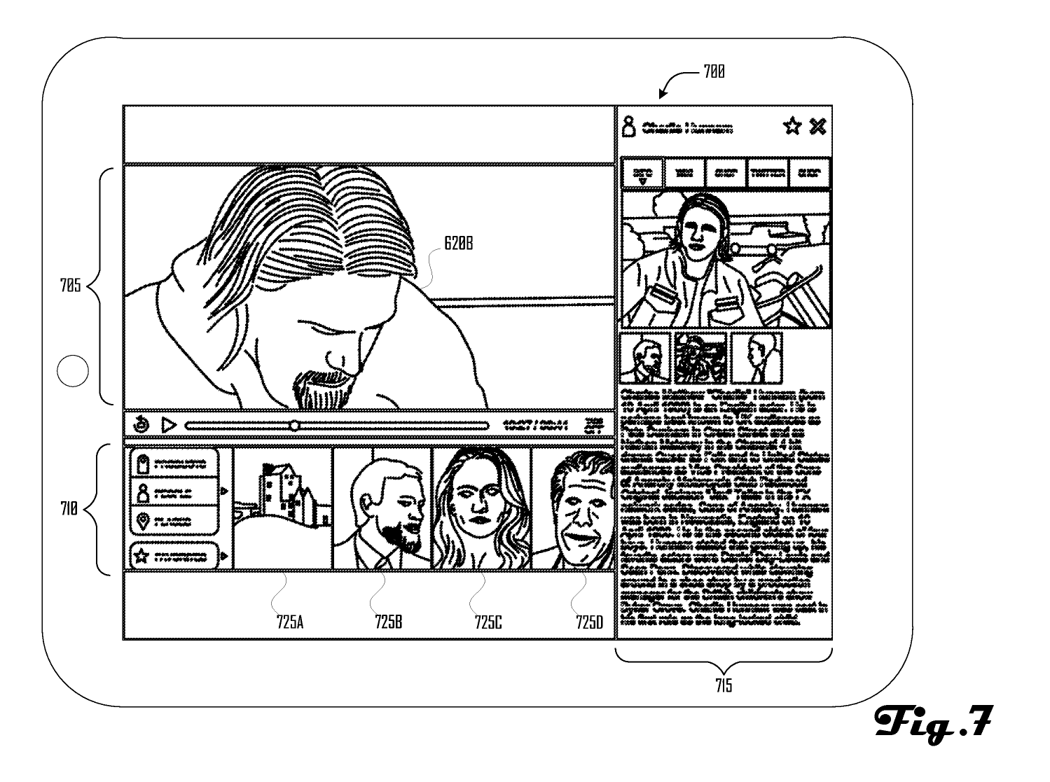

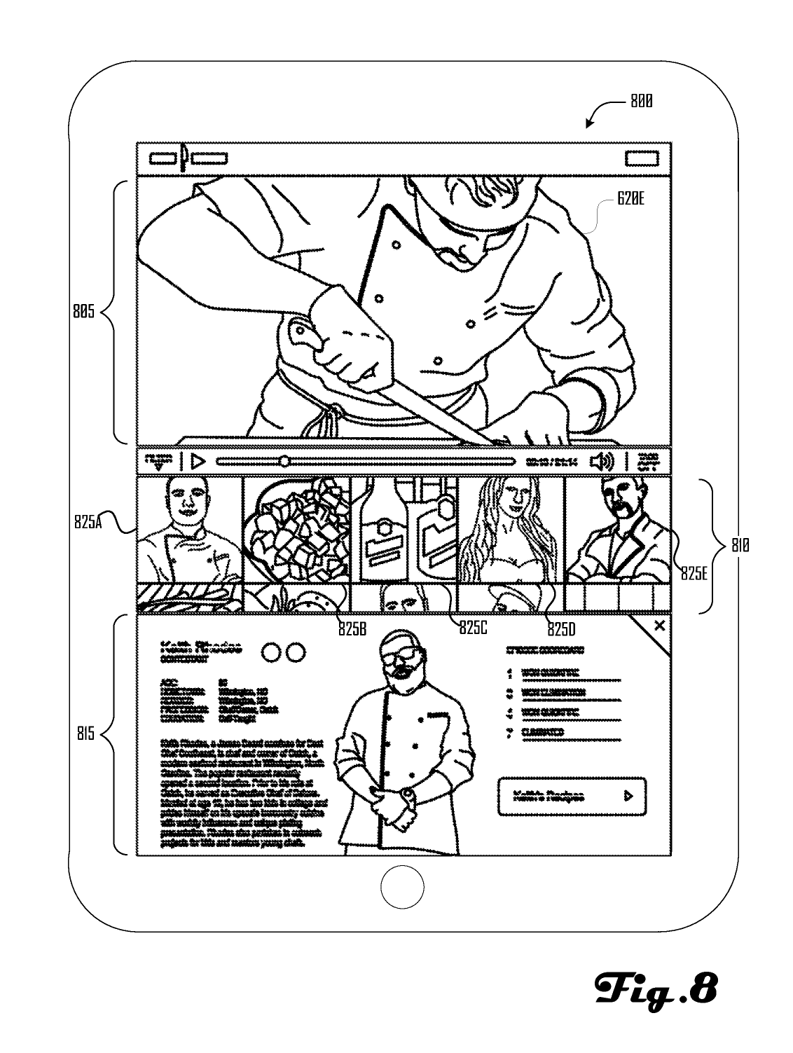

In block 405, routine 400 obtains an indication that a user has selected an asset currently depicted in a rendered-media pane. For example, in some embodiments, the user may use a pointing device or other input device to select or otherwise activate a selectable asset control currently presented within an assets pane, such as assets pane 510 (see FIG. 5, discussed below), assets pane 710 (see FIG. 7, discussed below), and/or assets pane 810 (see FIG. 8, discussed below).

In other embodiments, the user may use a similar input device to select or otherwise indicate an asset that is currently presented in a rendered-media pane, such as media-playback pane 505 (see FIG. 5, discussed below), media-playback pane 705 (see FIG. 7, discussed below), and/or media-playback pane 805 (see FIG. 8, discussed below).

In block 410, routine 400 obtains context data corresponding to the asset selected in block 405. For example, in some embodiments, asset time-line data (e.g., the asset time-line data obtained in block 310 (see FIG. 3, discussed above)) may specify one or more resource identifiers or resource locaters identifying one or more resources at which context data associated with the selected asset may be obtained. In such embodiments, obtaining context data may include retrieving a specified resource from a remote or local data store.

In other embodiments, asset time-line data may include context data instead of or in addition to one or more context-data resource identifiers or locaters. For example, in one embodiment, asset time-line data may include a data structure including asset entries having asset metadata such as some or all of the following.

{

“Asset ID”: “d13b7e51ec93”,
“Media ID”: “5d0b431d63f1”,
“Asset Type”: “Person”,
“AssetControl”: “/asset/d13b7e51ec93/thumbnail.jpg”,
“Asset Context Data”:
“http://en.wikipedia.org/wiki/Art_Arterton”,
“Time Start”: 15,
“Time End”: 22.5,
“Coordinates”: [

0.35,
0.5

],
“ShortBio”: “Art Arterton is an American actor born June 3,

1984 in Poughkeepsie, New York. He is best known for playing \“Jimmy
the Chipmunk\” in the children's television series \“Teenage Mobster
Rodents\”.”

}

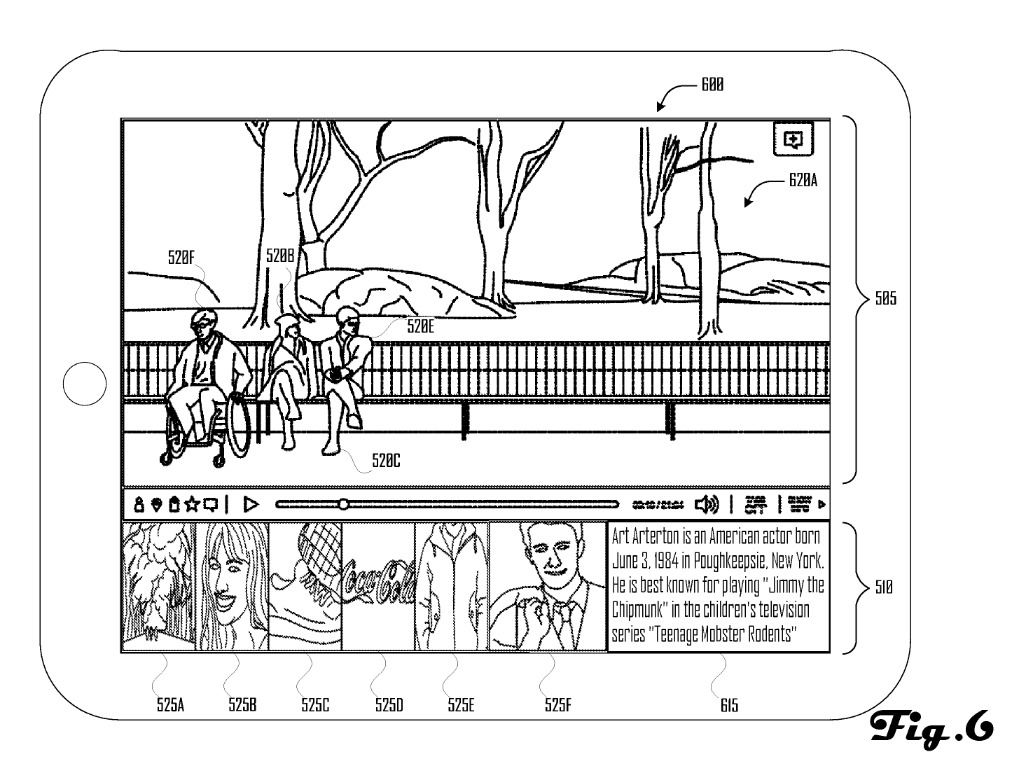

In block 415, routine 400 presents context data to the user while the media continues to render. In some embodiments, presenting context data associated with the asset selected in block 405 may include reconfiguring an assets pane to present the context data. See, e.g., context-data display 615 (see FIG. 6, discussed below).

In other embodiments, presenting context data associated with the asset selected in block 405 may include displaying and/or reconfiguring a context pane. See, e.g., context pane 715 (see FIG. 7, discussed below); context pane 815 (see FIG. 8, discussed below).

Having presented context data associated with the asset selected in block 405, routine 400 ends in ending block 499. In some embodiments, routine 400 may be invoked one or more times during the presentation of media data, whenever the user selects a currently-displayed asset.

FIG. 5 illustrates an exemplary context-aware media-rendering user interface, such as may be generated by media-playback device 200 in accordance with one embodiment.

User interface 500 includes media-playback pane 505, in which renderable media data is rendered. The illustrated media content presents a scene in which three individuals are seated on or near a bench in a park-like setting. Although not apparent from the illustration, the individuals in the rendered scene may be considered for explanatory purposes to be discussing popular mass-market cola beverages.

User interface 500 also includes assets pane 510, in which currently-presented asset controls 525A-F are displayed. In particular, asset control 525A corresponds to Asset5A (the park-like location in which the current scene takes place). Similarly, asset control 525B and asset control 525F correspond respectively to person asset 520B and person asset 520F (two of the individuals currently presented in the rendered scene); asset control 525C and asset control 525E correspond respectively to object asset 520C and object asset 520E (articles of clothing worn by an individual currently presented in the rendered scene); and asset control 525D corresponds to object asset 520D (the subject of a conversation taking place in the currently presented scene).

The illustrated media content also presents other elements (e.g., a park bench, a wheelchair, et al) that are not represented in assets pane 510, indicating that those elements may not be associated with any asset metadata.

FIG. 6 illustrates an exemplary context-aware media-rendering user interface, such as may be generated by media-playback device 200 in accordance with one embodiment.

User interface 600 is similar to user interface 500, but assets pane 510 has been reconfigured to present context-data display 615. In various embodiments, such a reconfiguration may be initiated if the user activates an asset control (e.g., asset control 525F) and/or selects an asset (e.g., person asset 520F) as displayed in media-playback pane 505.

FIG. 7 illustrates an exemplary context-aware media-rendering user interface, such as may be generated by media-playback device 200 in accordance with one embodiment.

User interface 700 includes media-playback pane 705, in which renderable media data is rendered. The illustrated media content presents a scene in which one individual is depicted in the instant frame. Although not apparent from the illustration, for explanatory purposes, the scene surrounding the instant frame may take place at or near some location and may involve or relate to other individuals not shown in the illustrated frame.

User interface 700 also includes assets pane 710, in which currently-presented asset controls 725A-D are displayed. In particular, asset control 725A corresponds to a location in which the current scene takes place. Similarly, asset control 725B corresponds to person asset 720B (the individual currently presented in the instant frame); while asset control 725C and asset control 725D correspond respectively to two other individuals who may have recently been depicted and/or discussed in the current scene, or who may otherwise be associated with the current scene.

User interface 700 also includes context pane 715, which displays information about an asset selected via an asset control (e.g., asset control 725B) that is currently or previously presented in assets pane 710, or selected by touching, clicking, gesturing, or otherwise indicating an asset (e.g. person asset 720B) that is or was visually depicted in media-playback pane 705.

FIG. 8 illustrates an exemplary context-aware media-rendering user interface, such as may be generated by media-playback device 200 in accordance with one embodiment.

User interface 800 includes media-playback pane 805, in which renderable media data is rendered. The illustrated media content presents a scene in which one individual is depicted in the instant frame. Although not apparent from the illustration, for explanatory purposes, the scene surrounding the instant frame may take place at or near some location and may involve or relate to other individuals and/or objects not shown in the illustrated frame.

User interface 800 also includes assets pane 810, in which currently-presented asset controls 825A-E are displayed. In particular, asset control 825E corresponds to person asset 820E (the individual currently presented in the instant frame). Asset control 825A and asset control 825D correspond respectively to two other individuals who may have recently been depicted and/or discussed in the current scene, or who may otherwise be associated with the current scene. Asset control 825B and asset control 825C correspond respectively to objects that may have been depicted and/or discussed in the current scene, or that may otherwise be associated with the current scene.

User interface 800 also includes context pane 815, which displays information about an asset selected via an asset control that is currently or previously presented in assets pane 810, or selected by touching, clicking, gesturing, or otherwise indicating an asset that is or was visually depicted in media-playback pane 805. As illustrated in FIG. 8, context pane 815 presents information about a person asset that is not currently represented by an asset control in currently-presented asset controls 825A-E. The user may have activated a previously-presented asset control during a time when the person asset in question was depicted in or otherwise associated with a scene rendered in media-playback pane 805.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A media-playback-device-implemented method for rendering context-aware media, the method comprising:
obtaining, by the media-playback device, renderable media data that, when rendered over a duration of time, presents a plurality of assets at various points within said duration of time;
obtaining, by the media-playback device, predefined asset time-line data comprising a plurality of asset identifiers corresponding respectively to said plurality of assets, said predefined asset time-line data further specifying for each asset of said plurality of assets, at least one time range during said duration of time in which each asset is presented and an asset control corresponding to each asset;
generating, by the media-playback device, a user-interface comprising a media-playback pane and an assets pane;
rendering, by the media-playback device, said renderable media data to said media-playback pane; and
while rendering said renderable media data to said media-playback pane:
continually identifying, according to said predefined asset time-line data, one or more assets that are currently presented in said media-playback pane; and
continually updating said assets pane to display, according to said predefined asset time-line data, a selectable asset control corresponding to each of said one or more currently-presented assets.

2. The method of claim 1, further comprising, while rendering said renderable media data to said media-playback pane:
obtaining an indication that a user has selected a selectable asset control that is currently displayed in said assets pane;
in response to receiving said indication, retrieving asset context data corresponding to said selected selectable asset control; and
presenting the retrieved asset context data to said user.

3. The method of claim 2, wherein:
said predefined asset time-line data further comprises asset context data to be presented upon user-selection of each asset; and
wherein retrieving asset context data comprises retrieving asset context data from said predefined asset time-line data.

4. The method of claim 2, wherein presenting the retrieved asset context data to said user comprises updating said assets pane to display the retrieved asset context data in addition to a selectable asset control corresponding to each of said one or more currently-presented assets.

5. The method of claim 2, wherein:
said user-interface further comprises a context pane; and
wherein presenting the retrieved asset context data to said user comprises updating said context pane to display the retrieved asset context data.

6. The method of claim 1, wherein said predefined asset time-line data further comprises asset-position data specifying a spatial position and/or region within said media-playback pane at which each asset is presented during a corresponding time range.

7. The method of claim 6, further comprising, while rendering said renderable media data to said media-playback pane:
obtaining an indication that a user has selected a spatial position and/or region corresponding to an asset that is currently presented in said media-playback pane;
in response to receiving said indication, retrieving from said predefined asset time-line data asset context data corresponding to said selected spatial position and/or region; and
presenting the retrieved asset context data to said user.

8. The method of claim 1, wherein said predefined asset time-line data further comprises asset type data categorizing each asset as being of a predetermined asset type.

9. The method of claim 8, wherein said predetermined asset type selected from an object type, a person type, and a location type.

10. A computing apparatus comprising a processor and a memory having stored thereon instructions that when executed by the processor, configure the apparatus to perform a method for rendering context-aware media, the method comprising:
obtaining renderable media data that, when rendered over a duration of time, presents a plurality of assets at various points within said duration of time;
obtaining predefined asset time-line data comprising a plurality of asset identifiers corresponding respectively to said plurality of assets, said predefined asset time-line data further specifying for each asset of said plurality of assets, at least one time range during said duration of time in which each asset is presented and an asset control corresponding to each asset;
generating a user-interface comprising a media-playback pane and an assets pane;
rendering said renderable media data to said media-playback pane; and
while rendering said renderable media data to said media-playback pane:
continually identifying, according to said predefined asset time-line data, one or more assets that are currently presented in said media-playback pane; and
continually updating said assets pane to display, according to said predefined asset time-line data, a selectable asset control corresponding to each of said one or more currently-presented assets.

11. The apparatus of claim 10, further comprising, while rendering said renderable media data to said media-playback pane:
obtaining an indication that a user has selected a selectable asset control that is currently displayed in said assets pane;
in response to receiving said indication, retrieving asset context data corresponding to said selected selectable asset control; and
presenting the retrieved asset context data to said user.

12. The apparatus of claim 11, wherein:
said predefined asset time-line data further comprises asset context data to be presented upon user-selection of each asset; and
wherein retrieving asset context data comprises retrieving asset context data from said predefined asset time-line data.

13. The apparatus of claim 11, wherein presenting the retrieved asset context data to said user comprises updating said assets pane to display the retrieved asset context data in addition to a selectable asset control corresponding to each of said one or more currently-presented assets.

14. The apparatus of claim 11, wherein:
said user-interface further comprises a context pane; and
wherein presenting the retrieved asset context data to said user comprises updating said context pane to display the retrieved asset context data.

15. The apparatus of claim 10, wherein said predefined asset time-line data further comprises asset-position data specifying a spatial position and/or region within said media-playback pane at which each asset is presented during a corresponding time range.

16. A non-transient computer-readable storage medium having stored thereon instructions that when executed by a processor, configure the processor to perform a method for rendering context-aware media, the method comprising:
obtaining renderable media data that, when rendered over a duration of time, presents a plurality of assets at various points within said duration of time;
obtaining predefined asset time-line data comprising a plurality of asset identifiers corresponding respectively to said plurality of assets, said predefined asset time-line data further specifying for each asset of said plurality of assets, at least one time range during said duration of time in which each asset is presented and an asset control corresponding to each asset;
generating a user-interface comprising a media-playback pane and an assets pane;
rendering said renderable media data to said media-playback pane; and
while rendering said renderable media data to said media-playback pane:
continually identifying, according to said predefined asset time-line data, one or more assets that are currently presented in said media-playback pane; and
continually updating said assets pane to display, according to said predefined asset time-line data, a selectable asset control corresponding to each of said one or more currently-presented assets.

17. The storage medium of claim 16, further comprising, while rendering said renderable media data to said media-playback pane:
obtaining an indication that a user has selected a selectable asset control that is currently displayed in said assets pane;
in response to receiving said indication, retrieving asset context data corresponding to said selected selectable asset control; and
presenting the retrieved asset context data to said user.

18. The storage medium of claim 17, wherein:
said predefined asset time-line data further comprises asset context data to be presented upon user-selection of each asset; and
wherein retrieving asset context data comprises retrieving asset context data from said predefined asset time-line data.

19. The storage medium of claim 17, wherein presenting the retrieved asset context data to said user comprises updating said assets pane to display the retrieved asset context data in addition to a selectable asset control corresponding to each of said one or more currently-presented assets.

20. The storage medium of claim 17, wherein:
said user-interface further comprises a context pane; and
wherein presenting the retrieved asset context data to said user comprises updating said context pane to display the retrieved asset context data.

21. The storage medium of claim 16, wherein said predefined asset time-line data further comprises asset-position data specifying a spatial position and/or region within said media-playback pane at which each asset is presented during a corresponding time range.
